(19) United States
(12) Patent Application Publication
(10) Pub. No.: US 2024/0193987 A1
(43) Pub. Date: Jun. 13, 2024

(54) FACE LIVENESS DETECTION METHOD, TERMINAL DEVICE AND NON-TRANSITORY COMPUTER-READABLE STORAGE MEDIUM

(71) Applicant: SHENZHEN PAX SMART NEW TECHNOLOGY CO., LTD., Shenzhen (CN)

(72) Inventors: Chenghe YANG, Shenzhen (CN); Jiansheng ZENG, Shenzhen (CN); Guiyuan LI, Shenzhen (CN); Yu WANG, Shenzhen (CN)

(21) Appl. No.: 18/282,666

(22) PCT Filed: Mar. 10, 2022
(86) PCT No.: PCT/CN2022/080158

§ 371 Date: Sep. 18, 2023

(30) Foreign Application Priority Data
Mar. 22, 2021 (CN) 202110303487.0

(51) Int. Cl. G06V 40/16; G06T 11/40; G06V 10/44; G06V 10/56; G06V 10/82; G06V 40/40

(52) U.S. Cl. CPC G06V 40/162; G06T 11/40; G06V 10/44; G06V 10/56; G06V 10/82; G06V 40/171; G06V 40/45

(57) ABSTRACT

The present application is applicable to the field of image processing technologies, and provides a face liveness detection method, a terminal device, and a non-transitory computer-readable storage medium. The method includes: obtaining an image to be processed, where the image to be processed includes a facial image; detecting a plurality of facial contour key points in the image to be processed; cropping the facial image in the image to be processed according to the plurality of facial contour key points; and inputting the facial image into a trained liveness detection architecture, and outputting a liveness detection result through the trained liveness detection architecture. An accuracy of face liveness detection may be effectively improved through the aforesaid face liveness detection method.

### CROSS-REFERENCE TO RELATED APPLICATIONS

This application is a 35 U.S.C. § 371 national stage application of PCT patent application No. PCT/CN2022/080158, filed on Mar. 10, 2022, which claims priority to Chinese patent application No. 202110303487.0, filed on Mar. 22, 2021, the entire contents each of which are incorporated herein by reference.

### FIELD

The present application relates to the field of image processing technologies, and more particularly, to a face liveness detection method, a terminal device and a non-transitory computer-readable storage medium.

### BACKGROUND

With the development of image processing technology, face detection gradually becomes the most potential biological identity verification method, and is widely used to the fields of financial payment, safety prevention and control, media entertainment and the like. In the existing face detection technology, in order to avoid a forged facial image (e.g., a printed facial image, a face mask or a facial image in a screen of an electronic device, etc.), face liveness detection generally needs to be performed, that is, whether a face in a collected image is a real face or a forged face is determined.

When the face liveness detection is performed, the face liveness detection is usually performed according to the collected image. Since the collected image contains a large amount of background information, however, the background information may interfere facial feature information in the collected image, and thereby affecting an accuracy of a liveness detection result.

### SUMMARY

Embodiments of the present application provide a face liveness detection method, a terminal device and a computer-readable storage medium that can improve the accuracy of face liveness detection effectively.

According to the first aspect of the embodiments of the present application, a face liveness detection method is provided. The method includes:
obtaining an image to be processed, where the image to be processed comprises a facial image;
detecting a plurality of facial contour key points in the image to be processed;
cropping the facial image in the image to be processed according to the plurality of facial contour key points: and
inputting the facial image into a trained liveness detection architecture, and outputting a liveness detection result.

In this embodiment of the present application, the facial contour key points in the image to be processed are detected firstly. Then, a facial image in the image to be processed is cropped according to the facial contour key points. The execution of this method is equivalent to filtering out a background image excluding the facial image in the image to be processed. Then, the facial image is input into the trained liveness detection architecture, and a liveness detection result is output. By performing this method, the interference of the background information in the image to be processed on the facial feature information is avoided, and the accuracy of liveness detection is effectively improved.

In one embodiment, said detecting the plurality of facial contour key points in the image to be processed includes:
obtaining a plurality of facial feature key points in the facial image of the image to be processed; and
determining the facial contour key points from the plurality of facial feature key points.

In one embodiment, said determining the plurality of facial contour key points from the plurality of facial feature key points includes:
determining boundary points in the plurality of facial feature key points; and
determining the plurality of facial contour key points according to the boundary points.

In one embodiment, said cropping the facial image in the image to be processed according to the facial contour key points includes:
obtaining a target layer according to the facial contour key points, where the target layer includes a first region filled with a first preset color and a second region filled with a second preset color, the first region is a region determined according to the facial contour key points, and the second region is a region excluding the first region in the target layer;
performing an image overlay processing on the target layer and the image to be processed to obtain the facial image.

In one embodiment, said obtaining the target layer according to the plurality of facial contour key points comprises:
delineating the first region according to the plurality of facial contour key points on a preset layer filled with the second preset color: and
filling the first region in the preset layer with the first preset color to obtain the target layer.

In one embodiment, the liveness detection architecture includes a first feature extractor:
the first feature extractor includes a first network and a second network, and the first network and the second network are connected in parallel;
the first network includes a first average pooling layer and a first convolution layer;
the second network is an inverted residual network.

In one embodiment, the liveness detection architecture further includes an attention mechanism architecture.

According to the second aspect of the embodiments of the present application, a terminal device is provided. This terminal device includes a memory, a processor and a computer program stored in the memory and executed by the processor. The processor is configured to, when executing the computer program, implement steps of the aforesaid face liveness detection method.

According to the third aspect of the embodiments of the present application, a non-transitory computer-readable storage medium is provided. The non-transitory computer-readable storage medium stores a computer program, that, when executed by a processor, causes the processor to perform any face liveness detection method as described in the first aspect.

According to the fourth aspect of the embodiments of the present application, a computer program product is provided. The computer program product stores a computer program, that, when executed by a terminal device, causes the terminal device to perform any face liveness detection method as described in the first aspect.

It can be understood that, regarding the beneficial effects in the second aspect, the third aspect, the fourth aspect, reference can be made to the relevant descriptions in the first aspect. The beneficial effects in the second aspect, the third aspect, and the fourth aspect are not repeatedly described herein.

### DESCRIPTION OF THE DRAWINGS

In order to describe the embodiments of the present application more clearly, a brief introduction regarding the accompanying drawings that need to be used for describing the embodiments of the present application or the existing technologies is given below. It is obvious that the accompanying drawings described below are merely some embodiments of the present application, a person of ordinary skill in the art can also acquire other drawings according to the current drawings without paying creative efforts.

FIG. 1 illustrates a schematic flow diagram of a face liveness detection method in accordance with one embodiment of the present application:

FIG. 2 illustrates a schematic diagram of a plurality of facial feature key points in accordance with one embodiment of the present application:

FIG. 3 illustrates a schematic diagram of a plurality of facial contour key points in accordance with one embodiment of the present application:

FIG. 4 illustrates a schematic diagram of removal of background information in accordance with one embodiment of the present application:

FIG. 5 illustrates a schematic structural diagram of a first feature extractor in accordance with one embodiment of the present application;

FIG. 6 illustrates a schematic structural diagram of an attention mechanism in accordance with one embodiment of the present application:

FIG. 7 illustrates a schematic structural diagram of a liveness detection architecture in accordance with one embodiment of the present application: and

FIG. 8 illustrates a schematic structural diagram of a terminal device in accordance with one embodiment of the present application.

### DETAILED DESCRIPTION OF EMBODIMENTS

In the following descriptions, in order to describe but not intended to limit the present application, concrete details including specific system structure and technique are proposed to facilitate a comprehensive understanding of the embodiments of the present application. However, a person of ordinarily skill in the art should understand that, the present application can also be implemented in some other embodiments from which these concrete details are excluded. In other conditions, detailed explanations of method, circuit, device and system well known to the public are omitted, so that unnecessary details which are disadvantageous to understanding of the description of the present application may be avoided.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

In addition, in the descriptions of the present application, terms such as “first” and “second”, “third”, etc., are only used for distinguishing purpose in description, but shouldn't be interpreted as indication or implication of a relative importance.

The descriptions of “referring to one embodiment” or “referring to some embodiments”, or the like as described in the specification of the present application means that a specific feature, structure, or characters which are described with reference to this embodiment are included in one embodiment or some embodiments of the present application. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless otherwise they are specially emphasize in other manner.

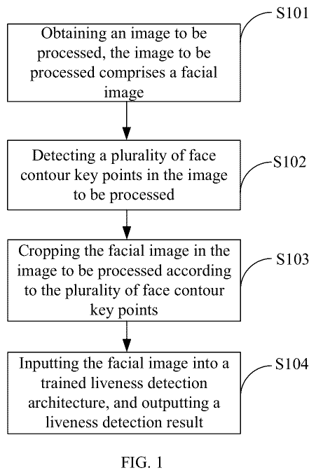

Referring to FIG. 1, which is a schematic flowchart of face liveness detection method implemented by a terminal device 9 according to one embodiment of the present application, as illustration rather than limitation, the face liveness detection method may include the following steps:

In a step of S101, an image to be processed is obtained, where the image to be processed includes a facial image.

The image to be processed may be red, green and blue (RGB) images. However, when the RGB images are used for liveness detection, a liveness detection effect is poor. Thus, the image to be processed in this embodiment of the present application is an infrared image. In practical application, an infrared binocular camera may be used to collect infrared image.

The image to be processed generally includes a facial image and a background image. In practical application, liveness or non-liveness image may exist in the background image of the collected image to be processed. If the image to be processed is input into a liveness detection architecture (i.e., the feature information of the background image and the facial image are considered comprehensively), the feature information corresponding to the background image in the image to be processed will interfere with the feature information corresponding to the facial image, thereby affecting an accuracy of the liveness detection result. In order to solve the problem mentioned above, in this embodiment of the present application, firstly, background information removal processing is performed on the image to be processed (see steps S102-S103) to obtain the facial image in the image to be processed. Then, the liveness detection is performed on the facial image. The details of the steps are described below.

In a step of S102, a plurality of facial contour key points in the image to be processed are detected.

In one embodiment, one implementation method of the step S102 may include:

a trained facial contour template is obtained; and the facial contour key points matching with the facial contour template are searched from the image to be processed.

In the aforesaid method, each of pixel points in the image to be processed needs to be processed, and the data processing amount is large. However, when the image to be processed is collected, angles of the face relative to a photographing device are often different (e.g., the face is a side face, the face is at a bottom view or at a top view), which may affect a matching result of the image to be processed and the facial contour template.

In order to improve the accuracy of facial contour key points detection, in this embodiment of the present application, another implementation method of the step S102 may include:

a plurality of facial feature key points on the facial image in the image to be processed are obtained: and a plurality of facial contour key points are determined from the plurality of facial feature key points.

The image to be processed can be input into the trained face detection architecture, and the plurality of facial feature key points are output through the face detection architecture.

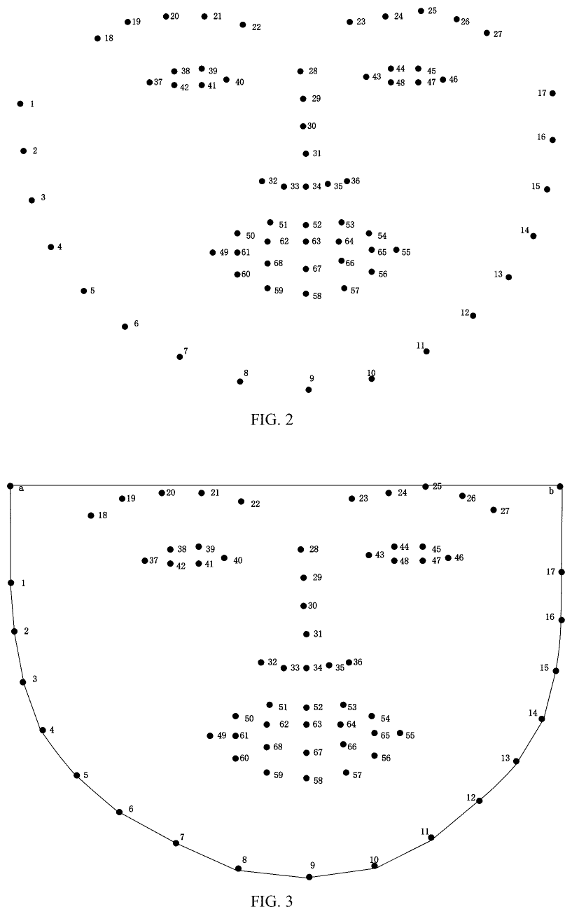

In one preferable embodiment, a face detection architecture with 68 key points may be used. FIG. 2 illustrates a schematic diagram of the plurality of facial feature key points in accordance with one embodiment of the present application. The image to be processed is input into the trained face detection architecture, and location marks of the facial feature key points 1-68 shown in FIG. 2 may be output.

Boundary lines of the facial image in the image to be processed may be detected according to an existing edge detection algorithm. Then, the facial feature key points passed by the boundary lines are determined as the facial contour key points. However, in practical application, the boundary between the facial image and the background image is sometimes unobvious. Thus, the existing edge detection algorithm cannot accurately detect the boundary lines of the facial image, and hence cannot determine the facial contour key points according to the boundary lines accordingly.

In order to solve the above problem, in this embodiment of the present application, as an alternative, the step of determining the facial contour key points from the plurality of facial feature key points may include:

determining the boundary points in the plurality of facial feature key points, and determining the plurality of facial contour key points according to the boundary points.

For example, as shown in FIG. 2, in the facial feature key points 1-68, the facial features key points 1-17 and the facial feature key points 18-27 are boundary points.

There may exist some implementation methods for determining the facial contour key points according to the boundary points, which are listed below:

First, boundary points are determined as facial contour key points.

For example, as shown in FIG. 2, boundary points 1-17 and 18-27 are determined as facial contour key points.

Second, a boundary point with the maximum abscissa, a boundary point with the minimum abscissa, a boundary point with the maximum ordinate and a boundary point with the minimum ordinate are determined as the boundary point of the facial contour.

For example, as shown in FIG. 2, boundary points 1, 9, 16, and 25 are determined as facial contour key points.

Third, an abscissa maximum value, an abscissa minimum value and an ordinate minimum value in the boundary points are calculated. A first vertex key point is determined according to the abscissa maximum value and the ordinate minimum value, and a second vertex key point is determined according to the abscissa minimum value and the ordinate minimum value. The boundary points 1-17, the first vertex key point and the second vertex key point are determined as the facial contour key points.

FIG. 3 illustrates a schematic diagram of the facial contour key points according to one embodiment of the present application. As shown in FIG. 3, the first vertex key point is represented by a (see the vertex at the upper left corner in FIG. 3), the second vertex key point (see the vertex at the upper right corner in FIG. 3) is b, and the contour of the facial image can be determined by the plurality of facial contour key points a, b, and the boundary points 1-17.

The contour of the facial image determined by the first method is smaller, and part of facial feature information is lost. The contour of the facial image determined by the second method is the minimum rectangle containing the facial image, and the contour includes more background images. The contour of the facial image determined by the third method is very appropriate, not only the integrity of the facial image is ensured, but also the background pattern is filtered completely.

In a step of S103, the facial image in the image to be processed is cropped according to the facial contour key points.

In one embodiment, one implementation method of the step S103 includes:

A facial contour boundary line is fitted according to the facial contour key points: and the facial image is cropped from the image to be processed according to the facial contour boundary line.

In another embodiment, the implementation method of the step S103 includes:

A target layer is obtained according to the facial contour key points. The target layer includes a first area filled with a first preset color and a second area filled with a second preset color, the first area is an area determined according to the facial contour key points, and the second area is an area excluding the first area in the target layer. An image overlay processing is performed on the target layer and the image to be processed so as to obtain the facial image.

In one embodiment, one implementation method of obtaining the target layer according to the facial contour key points includes:

The first area is delineated on the preset layer filled with the second preset color according to the facial contour key points: and the first area in the preset layer is filled with the first preset color to obtain the target layer.

Illustratively, a preset layer (e.g., a mask which may be stored in the form of program data) of black color (i.e., the second preset color) is first created: the facial contour key points are drawn as a curve through polylines function in OpenCV, and an area enclosed by the curve is determined as the first area: the first area is filled with white color (i.e., the first preset color) through fillpoly function to obtain the target layer. A pixel-by-pixel bitwise and processing is performed on the target layer and the image to be processed (i.e., performing image overlay processing) to obtain the facial image.

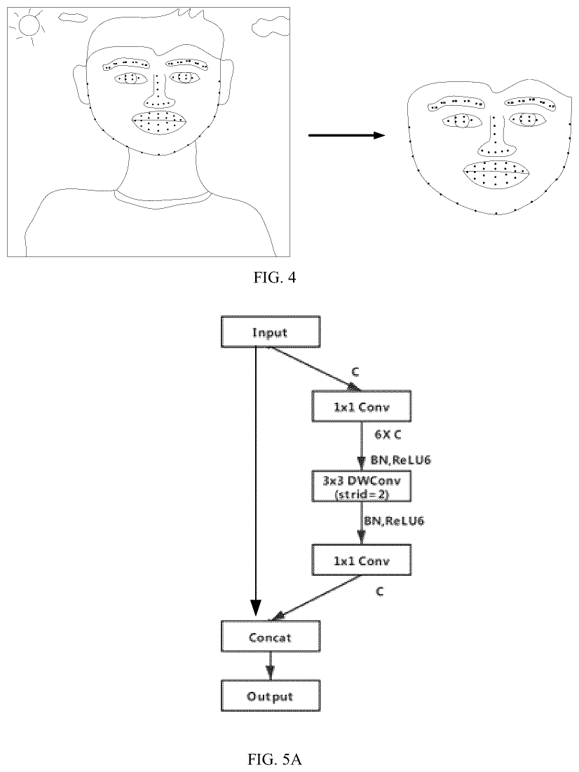

FIG. 4 illustrates a schematic diagram of a background image removal process according to one embodiment of the present application. The left image in FIG. 4 is the image to be processed before the background image removal processing is performed, and the right image in FIG. 4 is the facial image after the background image removal processing has been performed. As shown in FIG. 4, after performing the background image removal processing of the aforesaid steps S102-S103, the background image can be filtered while the complete facial image is retained.

In the step of S104, the facial image is input into a trained liveness detection architecture, and a liveness detection result is output from the trained liveness detection architecture.

In one embodiment, the liveness detection architecture includes a first feature extractor and an attention mechanism architecture.

Both the first feature extractor and the attention mechanism architecture are used for extracting features. The attention mechanism architecture may enhance a learning ability of features (e.g., light reflection of a human eye, skin texture features, etc.) with discriminability.

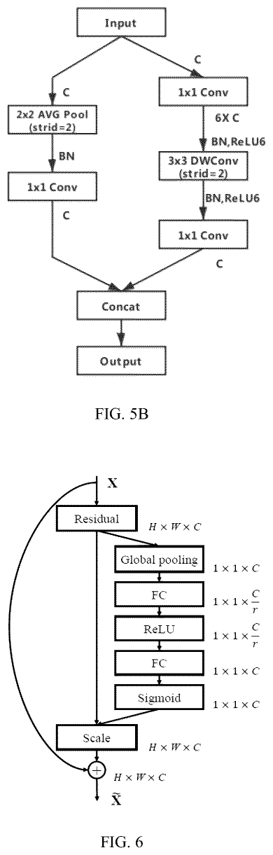

In one embodiment, referring to FIGS. 5A-5B, FIG. 5A illustrates a schematic structural diagram of a first feature extractor according to one embodiment of the present application. As shown in FIG. 5A, the first feature extractor includes a reversed residual network. The inverted residual network includes a second convolutional layer (1×1 CONV) for increasing of dimensionality, a third convolutional layer (3×3 FIG. ONV), and a fourth convolutional layer (1×1 CONV) for dimensionality reduction. The inverted residual network may be used to accelerate the process of feature learning.

In order to enhance the feature learning ability, optionally, a first network may be added on the basis of the first feature extractor. As shown in FIG. 5B, the first feature extractor includes the first network and a second network, and the first network and the second network are connected in parallel. The first network includes a first average pooling layer (2×2 AVG Pool) and a first convolutional layer (1×1 CONV). The second network is an inverted residual network. The first network and the second network share the input, the output of the first network and the output of the second network are subjected to feature fusion through a feature fusion layer (concat) and an output of the first feature extractor is obtained.

In one embodiment, the attention mechanism architecture may use a SENet module. FIG. 6 is a schematic structural diagram of the attention mechanism architecture according to one embodiment of the present application. As shown in FIG. 6, the attention mechanism architecture includes a residual layer, a global pooling layer, fully connected layers (FC, fully connected layers), an excitation layer (ReLU), an activation function layer (Sigmoid), and a scale conversion layer (Scale).

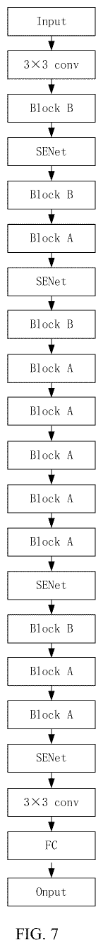

For example, referring to FIG. 7, FIG. 7 is a schematic structural diagram of a liveness detection architecture according to one embodiment of the present application. A Block A module in FIG. 7 is the first feature extractor shown in FIG. 5A, and a Block B module in FIG. 7 is the first feature extractor shown in FIG. 5B. In the liveness detection architecture shown in FIG. 7, the first feature extractor and the attention mechanism architecture perform feature extraction tasks alternatively. Last, the extracted feature vectors are fully connected to an output layer through FC. In a liveness detection process, the output feature vectors are converted into probability values through a classification layer (e.g., softmax), and whether the feature vectors are a liveness can be determined through the probability values. The liveness detection architecture shown in FIG. 7 is provided with strong defense capability and security for 2D and 3D facial images, and the accuracy of liveness detection is relatively high.

It should be noted that, the foregoing is merely one example of the liveness detection architecture, the number and the sequence of the modules are not specifically limited.

In the embodiments of the present application, firstly, the facial contour key points in the image to be processed are detected, then, the facial image in the image to be processed is cropped according to the facial contour key points, the execution of the method is equivalent to filtering out the background image excluding the facial image in the image to be processed. Then, the facial image is input into the trained liveness detection architecture, and the liveness detection result is output. By performing the aforesaid face liveness detection method, the interference of the background information in the image to be processed on the facial feature information is avoided, and the accuracy of liveness detection is effectively improved.

It should be understood that, the values of serial numbers of the steps in the aforesaid embodiments do not indicate an order of execution sequences of the steps. Instead, the execution sequences of the steps should be determined by the functionalities and internal logic of the steps, and thus shouldn't be regarded as limitation to implementation processes of the embodiments of the present application.

The person of ordinary skill in the art may understand clearly that, for the convenience of description and for conciseness, the dividing of the aforesaid various functional units and functional modules is merely described according to examples, in an actual application, the aforesaid functions may be assigned to different functional units and functional modules to be accomplished, that is, an inner structure of the device is divided into different functional units or modules, so that the whole or a part of functionalities described above can be accomplished. The various functional units and modules in the embodiments may be integrated into a processing unit, or each of the units exists independently and physically, or two or more than two of the units are integrated into a single unit. The aforesaid integrated unit may either by actualized in the form of hardware or in the form of software functional units. In addition, specific names of the various functional units and modules are only used to distinguish from each other conveniently, rather than being intended to limit the protection scope of the present application. Regarding the specific working process of the units and modules in the aforesaid system, reference may be made to a corresponding process in the aforesaid method embodiments, this specific working process is not repeatedly described herein.

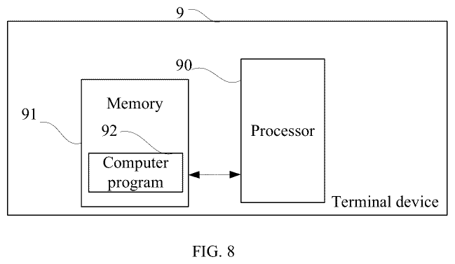

As shown in FIG. 8, FIG. 8 illustrates a schematic diagram of a terminal device 9 in accordance with one embodiment of the present application. The terminal device 9 includes: a processor 90 (only one processor is shown in FIG. 8), a memory 91, and a computer program 92 stored in the memory 91 and executable by the processor 90. The processor 90 is configured to, when executing the computer program 92, implement steps of the various method embodiments of the face liveness detection method as described above.

The terminal device 9 can be a computing device such as a desktop computer, a laptop computer, a palm computer, a cloud server, etc. The terminal device 9 may include, but is not limited to: the processor 90, the memory 91. A person of ordinary skill in the art can understand that, FIG. 8 is only one example of the terminal device 9, but should not be constituted as limitation to the terminal device 9, more or less components than the components shown in FIG. 8 may be included. Some components or different components may be combined: for example, the terminal device 9 may also include an input and output device, a network access device, etc.

The so-called processor 90 may be central processing unit (CPU), and may also be other general purpose processor, digital signal processor (DSP), application specific integrated circuit (ASIC), field-programmable gate array (FGPA), or some other programmable logic devices, discrete gate or transistor logic device, discrete hardware component, etc. The general purpose processor may be a microprocessor, as an alternative, the processor may also be any conventional processor, or the like.

In some embodiments, the memory 91 may be an internal storage unit of the terminal device 9, such as a hard disk or a memory of the terminal device 9. In some other embodiments, the memory 91 may also be an external storage device of the terminal device 9, such as a plug-in hard disk, a SMC (Smart Media Card), a SD (Secure Digital) card, a FC (Flash Card) equipped on the terminal device 9. Furthermore, the memory 91 may not only include the internal storage unit of the terminal device 9, but also include the external memory of the terminal device 9. The memory 91 is configured to store operating systems, applications, Boot Loader, data and other procedures, such as program codes of the compute program, etc. The memory 91 may also be configured to store data that has been output or being ready to be output temporarily.

A non-transitory computer-readable storage medium is further provided in one embodiment of the present application. The non-transitory computer-readable storage medium store a computer program, that, when executed by a processor, causes the processor to perform the steps of the various method embodiments of the face liveness detection method.

A computer program product is further provided in one embodiment of the present application. The computer program product is configured to, when executed on the terminal device 9, causes the terminal device 9 to perform the steps of the various method embodiments of the face liveness detection method.

The aforesaid embodiments are merely used to explain the technical solutions of the present application, and are not intended to limit the technical solutions of the present application. Although the present application has been described in detail with reference to the embodiments described above, a person of ordinary skill in the art should understand that the technical solutions described in these embodiments may still be modified, or some or all technical features in the embodiments may be equivalently replaced. However, these modifications or replacements do not make the essences of corresponding technical solutions to deviate from the spirit and the scope of the technical solutions of the embodiments of the present application, and should all be included in the protection scope of the present application.

1. A face liveness detection method performed by a terminal device, comprising:
obtaining an image to be processed, wherein the image to be processed comprises a facial image;
detecting a plurality of facial contour key points in the image to be processed;
cropping the facial image in the image to be processed according to the plurality of facial contour key points; and
inputting the facial image into a trained liveness detection architecture, and outputting a liveness detection result through the trained liveness detection architecture.

2. The face liveness detection method according to claim 1, wherein said detecting the plurality of facial contour key points in the image to be processed comprises:
obtaining a plurality of facial feature key points in the facial image of the image to be processed; and
determining the plurality of facial contour key points from the plurality of facial feature key points.

3. The face liveness detection method according to claim 2, wherein said determining the plurality of facial contour key points from the plurality of facial feature key points comprises:
determining a plurality of boundary points in the plurality of facial feature key points; and
determining the plurality of facial contour key points according to the plurality of boundary points.

4. The face liveness detection method according to claim 1, wherein said cropping the facial image in the image to be processed according to the plurality of facial contour key points comprises:
obtaining a target layer according to the plurality of facial contour key points, wherein the target layer comprises a first region filled with a first preset color and a second region filled with a second preset color, the first region is a region determined according to the plurality of facial contour key points, and the second region is a region excluding the first region in the target layer; and
performing an image overlay processing on the target layer and the image to be processed to obtain the facial image.

5. The face liveness detection method according to claim 4, wherein said obtaining the target layer according to the plurality of facial contour key points comprises:
delineating the first region on a preset layer filled with the second preset color according to the plurality of facial contour key points; and
filling the first region in on the preset layer with the first preset color to obtain the target layer.

6. The face liveness detection method according to claim 1, wherein the liveness detection architecture comprises a first feature extractor:
the first feature extractor comprises a first network and a second network, and wherein the first network and the second network are connected in parallel;
the first network comprises a first average pooling layer and a first convolution layer;
the second network is an inverted residual network.

7. The face liveness detection method according to claim 6, wherein the liveness detection architecture further comprises an attention mechanism architecture, and the attention mechanism architecture comprises a residual layer, a global pooling layer, fully connected layers, an excitation layer, an activation function layer, and a scale conversion layer.

8. (canceled)

9. A terminal device, comprising a memory, a processor and a computer program stored in the memory and executed by the processor, wherein the processor is configured to, when executing the computer program, perform steps of a face liveness detection method, comprising:
obtaining an image to be processed, wherein the image to be processed comprises a facial image;
detecting a plurality of facial contour key points in the image to be processed;
cropping the facial image in the image to be processed according to the facial contour key points; and
inputting the facial image into a trained liveness detection architecture, and outputting a liveness detection result through the trained liveness detection architecture.

10. A non-transitory computer-readable storage medium, which stores a computer program, that, when executed by a processor, causes the processor to implement steps of the face liveness detection method according to claim 1.

11. The terminal device according to claim 9, wherein the processor is further configured to perform the step of detecting the plurality of facial contour key points in the image to be processed by obtaining a plurality of facial feature key points in the facial image of the image to be processed, and determining the plurality of facial contour key points from the plurality of facial feature key points.

12. The terminal device according to claim 11, wherein the processor is further configured to perform the step of determining the plurality of facial contour key points from the plurality of facial feature key points by determining a plurality of boundary points in the plurality of facial feature key points, and determining the facial contour key points according to the plurality of boundary points.

13. The terminal device according to claim 9, wherein the processor is further configured to perform the step of cropping the facial image in the image to be processed according to the plurality of facial contour key points by:
obtaining a target layer according to the plurality of facial contour key points, wherein the target layer comprises a first region filled with a first preset color and a second region filled with a second preset color, the first region is a region determined according to the plurality of facial contour key points, and the second region is a region excluding the first region in the target layer; and
performing an image overlay processing on the target layer and the image to be processed to obtain the facial image.

14. The terminal device according to claim 13, wherein the processor is further configured to perform the step of obtaining the target layer according to the plurality of facial contour key points by delineating the first region on a preset layer filled with the second preset color according to the plurality of facial contour key points, and filling the first region in the preset layer with the first preset color to obtain the target layer.

15. The terminal device according to claim 9, wherein the liveness detection architecture comprises a first feature extractor:
the first feature extractor comprises a first network and a second network, and wherein the first network and the second network are connected in parallel;
the first network comprises a first average pooling layer and a first convolution layer;
the second network is an inverted residual network.

16. The terminal device according to claim 15, wherein the liveness detection architecture further comprises an attention mechanism architecture, and the attention mechanism architecture comprises a residual layer, a global pooling layer, fully connected layers, an excitation layer, an activation function layer, and a scale conversion layer.
